(19) United States
(12) Patent Application Publication
(10) Pub. No.: US 2026/0071714 A1
(43) Pub. Date: Mar. 12, 2026

(54) POLYMER COMPOSITE PIPE

(71) Applicant: ENOFLEX LIMITED, Southampton (GB)

(72) Inventor: Jonathan Hugh WILKINS, Cambridge (GB)

(73) Assignee: ENOFLEX LIMITED, Southampton (GB)

(21) Appl. No.: 19/388,649

(22) Filed: Nov. 13, 2025

Related U.S. Application Data
(63) Continuation of application No. PCT/GB2024/051299, filed on May 17, 2024.

(30) Foreign Application Priority Data
May 18, 2023 (GB) 2307447.9

(51) Int. Cl. F16L 59/147; B29C 70/30; B29C 70/70; B29K 23/00; B29K 223/00; B29K 705/02; B29L 23/00; B32B 15/085; B32B 15/20; B32B 27/32; F16L 9/147; F16L 59/14

(52) U.S. Cl. CPC F16L 59/147; B29C 70/30; B29C 70/70; B32B 15/085; B32B 15/20; B32B 27/32; F16L 9/147; F16L 59/141; B29K 2023/12; B29K 2223/12; B29K 2705/02; B29K 2995/0097; B29L 2023/22; B32B 2250/02; B32B 2307/7376; B32B 2311/24; B32B 2597/00

(57) ABSTRACT

A polymer composite pipe having a longitudinal axis is provided, having a polymer composite internal layer and a polymer composite pipe body disposed around and bonded to an exterior surface of the polymer composite internal layer. The polymer composite internal layer is either in the form of an annular cylinder, or in the form of a broken annular cylinder. The polymer composite pipe body includes at least one ply of wound polymer composite tape. A polymer composite is a material including polymer fibres embedded in a polymer matrix. A stratum of metal foil is embedded in the polymer composite internal layer and/or a stratum of metal foil is embedded in the polymer composite tape forming the ply or a ply of wound polymer composite tape. A method of manufacturing such a polymer composite pipe is also described.

### CROSS REFERENCE TO RELATED APPLICATIONS

This application is a continuation of International Patent Application No. PCT/GB2024/051299, filed May 17, 2024, which claims priority to GB Patent No. 2307447.9, filed May 18, 2023, the contents of each of which are incorporated by reference herein.

### FIELD OF THE INVENTION

The present invention relates to a polymer composite pipe, to a cryogenic pipe arrangement comprising the polymer composite pipe, to the use of the polymer composite pipe for transporting cryogenic fluid, and to methods of manufacturing the polymer composite pipe.

### BACKGROUND

The piping used to contain and/or to transport liquefied gases must be capable of withstanding very low temperatures, typically below −150° C. Such piping may, for example, be used to transport liquefied natural gas (LNG) or the liquefied components of air; it may also be used as the ‘cryostat’ component to maintain super-conducting electrical cables at the low temperatures necessary. As is known to the skilled person, these cables may be used for efficient transmission of electrical power over distances of 1 km or more. The cryostat component is in effect a pipe containing cryogenic fluids to cool the cable to the necessary temperatures at which super-conduction may occur. Liquid nitrogen at a temperature of around −190° C. is one such common fluid.

At such temperatures, carbon steels tend to crack, because they undergo a brittle-ductile transition which causes them to shatter, rather than deform. Typically, where metal piping is required, stainless steel 316 or steel combined with 9% Nickel is used (commercialised as ‘Inconel’ or ‘Invar’); these materials have a lower brittle-ductile transition temperature, so remain ductile at the cryogenic temperatures in question.

Polymer pipe for transporting cryogenic fluids is also known. WO 2016/102618 A1 describes a process for making a polymer composite pipe comprising wound layers of polymer composite tape. Composite polymer piping has a number of advantages over metal piping. These include the fact that it does not corrode; that it is flexible, so that it may, for example, be wound onto a spool for storage and transport, or easily accommodate bends; that it can be made in continuous lengths which may be several kilometres long avoiding the need for welds and that it may be relatively low in weight.

Pipes for cryogenic applications typically require thermal insulation to prevent or reduce heat transfer into the cryogenic fluid, and to prevent harm caused by “cold burns” in the case of accidental skin contact with the outside of the pipe. One established insulation technique is shown in FIG. 1: an outer pipe (1) is disposed around the inner pipe (2) containing the cryogenic fluid (3); between the outer pipe (1) and the inner pipe (2) a vacuum anulus (4) is provided which comprises no fluid and is held under vacuum. As is known to the skilled person, a vacuum is an efficient way to prevent heat transfer by conduction and convection. Typically, the vacuum is required to exist for periods of around 10 years between maintenance intervals.

It is important to minimise permeation of gas into the vacuum anulus, because the presence of such gas may degrade the vacuum and increase the transfer of heat across the vacuum annulus and into the cryogenic fluid. Sources of such gas may be the surrounding air from which gas may diffuse into and permeate through the wall of the outer pipe and into the annulus. Alternatively, gas may diffuse into and permeate through the wall of the inner pipe and into the annulus.

During operation, the inner pipe will typically contain fluid typically at cryogenic temperatures. During storage or periods out of service the inner pipe will contain air typically at ambient temperatures. In both situations, diffusion and permeation of gas may occur, with the rate being higher when the temperature is ambient, since diffusion kinetics increase with temperature.

With the exception of hydrogen, gas diffusion into and permeation through metals is usually negligible. Gas diffusion into and permeation across polymer pipes may not be negligible, to the extent that the vacuum anulus may become degraded. Moreover, if gas permeates into the polymer pipe, then the polymer pipe itself may become degraded, for example as a result of material delamination or blistering caused by gas depressurisation in the pipe wall.

Cryogenic pipe, for instance for use with super-conducting electrical cables, may undergo temperature decreases of the order of 200° C. when cooled after installation from ambient temperature to the operating temperature. The temperature decrease may lead to a significant length contraction along the longitudinal axis of the cryogenic pipe. If the pipe comprises materials having differing coefficients of thermal expansion, this may lead to differing degrees of contraction in the axial direction. This effect may, in turn, lead to the creation of stresses within the pipe wall and potentially also to delamination and failure of the pipe wall.

It is against this background that the present invention has been devised.

### SUMMARY

According to a first aspect, a polymer composite pipe having a longitudinal axis is provided comprising:
a. a polymer composite internal layer in the form of an annular cylinder, or in the form of a broken annular cylinder, having an exterior surface;
b. a polymer composite pipe body disposed around and bonded to the exterior surface, the polymer composite pipe body comprising at least one ply of wound polymer composite tape;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming the ply or a ply of wound polymer composite tape.

As used herein, the term “fibre” may refer to a single filament or may refer to a bundle or mesh of filaments associated with one another, such as by twisting them together.

As used herein, the term “ply” refers to a sub-layer for the case in which a layer comprises more than one ply of wound composite tape. In the exceptional case in which a layer comprises just a single ply of wound composite tape, then the term “ply” is synonymous with the term “layer”.

By placing a stratum of metal foil close to the fluid within the polymer composite pipe, permeation of gas may be prevented or reduced which may prevent or reduce consequential delamination or blistering of layers of the surrounding polymer composite pipe body, such as may be caused by depressurisation of permeated gas. Moreover, the polymer fibres embedded with the stratum of metal foil within the composite may bestow stiffness, which may prevent or reduce radial movement of the stratum of metal foil, thereby preventing or reducing blisters from forming. The polymer fibres may also improve tear-resistance, preventing or reducing breaks in the stratum of metal foil as a result of any radial movement that does occur. Lastly, locating the stratum of metal foil close to the fluid within the polymer composite pipe ensures that it has a diameter which is close to the pipe internal diameter; this may serve to minimise the amount of material needed to make the stratum of metal foil, which may lower the cost and be advantageous from an environmental perspective.

In one example of the first aspect of the invention, if a stratum of metal foil is embedded in the polymer composite internal layer, then the stratum of metal foil is coextensive with the polymer composite internal layer, and if a stratum of metal foil is embedded in the polymer composite tape forming the ply or a ply of wound polymer composite tape, then the stratum of metal foil is coextensive with that polymer composite tape.

In one example of the first aspect of the invention, the stratum of metal foil or a stratum of metal foil is embedded in the polymer composite tape forming the first ply of wound polymer composite tape, which is the ply bonded to the internal layer. According to this aspect the polymer composite pipe body comprises a second ply of wound polymer composite tape bonded to the first ply of wound polymer composite tape, wherein a stratum of metal foil is embedded in the second ply of wound polymer composite tape.

In one example of the first aspect of the invention, the metal foil comprises a metal selected from aluminium, copper, steel, titanium, or a mixture of one or more of those metals, or an alloy of one of those metals.

In one example of the first aspect of the invention, the metal foil comprises aluminium.

In one example of the first aspect of the invention, the stratum of metal foil has a thickness from 1 μm to 100 μm. In another example of the first aspect of the invention, the stratum of metal foil has a thickness from 20 μm to 85 μm. In a further example of the first aspect of the invention, the stratum of metal foil has a thickness from 20 μm to 30 μm or a thickness from 75 μm to 85 μm.

In one example of the first aspect of the invention:
a. if the stratum of metal foil is embedded in the polymer composite internal layer, then the polymer composite internal layer comprises the stratum of metal foil bonded between two sheets of polymer composite; and
b. if the stratum of metal foil is embedded in the polymer composite tape forming a ply of wound polymer composite tape, then that polymer composite tape comprises the stratum of metal foil bonded between two sheets of polymer composite.

The purpose of the internal layer is to provide a surface onto which the polymer composite pipe body may be disposed. If a layer, such as the internal layer is not provided, then it may be complex and challenging to make the pipe body, especially in the case in which the pipe body is made of layers of wound tape. The material of the internal layer may additionally be rolled to compact it. The presence of a stratum of metal foil embedded within the internal layer may enhance its ability to provide a surface onto which the polymer composite pipe body may be disposed.

In one example of the first aspect of the invention, the internal layer has a thickness of 0.1 mm-1 mm, or a thickness of 0.2 mm-0.7 mm.

In one example of the first aspect of the invention, the internal layer comprises first polymer fibres embedded in a first polymer matrix.

In one example, the first polymer fibres may comprise continuous fibres, non-woven fibres, knitted fibres or mixtures thereof.

The first polymer fibres and the first polymer matrix may comprise the same polymer or a different polymer.

In one example of the first aspect of the invention, the first polymer fibres and the first polymer matrix may comprise or consist of the same homopolymer, or one of them may comprise or consist of a copolymer thereof, or both of them may comprise or consist of a mixture of copolymer and homopolymer. In a further example, the homopolymer and/or the copolymer is a thermoplastic polymer.

In another example of the first aspect of the invention, the first polymer fibres and the first polymer matrix comprise or consist of the same polyolefin homopolymer, or one of them may comprise or consist of a copolymer of the polyolefin, or both of them may comprise or consist of a mixture of the polyolefin homopolymer and a polyolefin copolymer. In one example, the polyolefin is polyethylene or polypropylene. In a further example, the first polymer fibres consist of polypropylene or a copolymer thereof or mixtures thereof and the first polymer matrix consists of polypropylene or a copolymer thereof or mixtures thereof.

In one example of the first aspect of the invention, the first polymer fibres have a softening point which is higher than the softening point of the first polymer matrix. This may ensure that, if heat is applied to the polymer composite, for example during a heat compaction process or during welding and fusion processes, the first polymer matrix softens or melts, but the first polymer fibres do not soften or melt. A person skilled in polymer technology is aware of pairs of polymers which allow such a tailored softening point difference to be achieved.

In one example of the first aspect of the invention, the polymer composite tape comprises second polymer fibres embedded in a second polymer matrix.

In one example, the second polymer fibres may comprise continuous fibres, non-woven fibres, knitted fibres or mixtures thereof.

The arrangement of the second polymer fibres may be the same as or different from the arrangement of the first polymer fibres.

The second polymer fibres and the second polymer matrix may comprise the same polymer or a different polymer.

In one example of the first aspect of the invention, the second polymer fibres and the second polymer matrix may comprise or consist of the same homopolymer, or one of them may comprise or consist of a copolymer thereof, or both of them may comprise or consist of a mixture of copolymer and homopolymer. In a further example, the homopolymer and/or the copolymer is a thermoplastic polymer.

In another example of the first aspect of the invention, the second polymer fibres and the second polymer matrix comprise or consist of the same polyolefin homopolymer, or one of them may comprise or consist of a copolymer of the polyolefin, or both of them may comprise or consist of a mixture of the polyolefin homopolymer and a polyolefin copolymer. In one example, the polyolefin is polyethylene or polypropylene. In a further example, the second polymer fibres consist of polypropylene or a copolymer thereof or mixtures thereof and the second matrix consists of polypropylene or a copolymer thereof or mixtures thereof.

In one example of the first aspect of the invention, the second polymer fibres have a softening point which is higher than the softening point of the second polymer matrix. This may ensure that, if heat is applied to the polymer composite, for example during a heat compaction process or during welding and fusion processes, the second polymer matrix softens or melts, but the second polymer fibres do not soften or melt. A person skilled in polymer technology is aware of pairs of polymers which allow such a tailored softening point difference to be achieved.

In one example of the first aspect of the invention, the first polymer matrix and the second polymer matrix comprise the same polymer or a different polymer.

In another example of the first aspect of the invention, the first polymer matrix and the second polymer matrix may comprise or consist of the same homopolymer, or one of them may comprise or consist of a copolymer thereof, or both of them may comprise or consist of a mixture of copolymer and homopolymer. In a further example, the homopolymer and/or the copolymer is a thermoplastic polymer.

In a further example of the first aspect of the invention, the first polymer matrix and the second polymer matrix comprise or consist of the same polyolefin homopolymer, or one of them may comprise or consist of a copolymer of the polyolefin, or both of them may comprise or consist of a mixture of the polyolefin homopolymer and a polyolefin copolymer. In one example, the polyolefin is polyethylene or polypropylene. In a further example, the first polymer matrix consists of polypropylene or a copolymer thereof or mixtures thereof and the second polymer matrix consists of polypropylene or a copolymer thereof or mixtures thereof.

In one example of the first aspect of the invention, the polymer composite pipe comprises a cryogenic fluid having a temperature below −30° C. According to this aspect, the fluid may be a liquefied gas such as LNG, liquefied nitrogen, or liquefied carbon dioxide.

According to a second aspect of the invention, a cryogenic pipe arrangement is provided comprising a polymer composite pipe of the first aspect of the invention disposed within an outer pipe such that there is a gap between the polymer composite pipe and the outer pipe, the arrangement being adapted to create and sustain a vacuum within the gap. According to this aspect of the invention, the polymer composite pipe may comprise a cryogenic fluid having a temperature below −30° C. or below −100°C. or below −150° C.

According to a third aspect of the invention, the use is provided of a polymer composite pipe of the first aspect of the invention for conveying a fluid having a temperature below −30° C. or below −100° C. or below −150° C.

According to a first alternative of a fourth aspect of the invention, a method is provided of manufacturing a polymer composite pipe having a longitudinal axis and comprising a polymer composite internal layer and a polymer composite pipe body, the method comprising:
a. providing a longitudinal sheet of polymer composite having a sheet width defined between a first longitudinal side edge and a second longitudinal side edge;
b. wrapping the longitudinal sheet of polymer composite around the longitudinal axis, such that the first longitudinal side edge and the second longitudinal side edge are contiguous or overlap one another to provide the internal layer which has the form of an annular cylinder having an exterior surface;
c. disposing the polymer composite pipe body around the internal layer by winding at least one ply of polymer composite tape around the exterior surface and bonding it to the exterior surface;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming a ply of wound polymer composite tape.

According to a second alternative of a fourth aspect of the invention, a method is provided of manufacturing a polymer composite pipe having a longitudinal axis and comprising a polymer composite internal layer and a polymer composite pipe body, the method comprising:
a. providing a longitudinal sheet of polymer composite having a sheet width defined between a first longitudinal side edge and a second longitudinal side edge;
b. wrapping the longitudinal sheet of polymer composite around the longitudinal axis to provide the internal layer in the form of a broken annular cylinder having a circumference which is greater than the sheet width, so that the internal layer comprises a longitudinally extending break defined between the first longitudinal side edge and the second longitudinal side edge, the internal layer having an exterior surface;
c. disposing the polymer composite pipe body around the internal layer by winding at least one ply of polymer composite tape around the exterior surface and bonding it to the exterior surface;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming a ply of wound polymer composite tape.

The polymer composite internal layer may be in the form of a broken annular cylinder. This construction may avoid an overlap of the first longitudinal side edge and the second longitudinal side edge. Such an overlap may, in some circumstances, give rise to a raised portion which may then be maintained or even magnified when subsequent layers of the polymer composite pipe body are applied, giving rise to an asymmetrical pipe. It is preferred to avoid this scenario. The longitudinally extending break typically represents a very small area, with a width of 1 mm or less. In the case in which the stratum of metal foil is embedded within the internal layer, then a significant reduction in gas permeation through the rest of the internal layer is still provided as a result of the presence of the stratum of metal foil. Moreover, if needed, a stratum of metal foil may additionally be embedded in the polymer composite tape forming one or more plies of wound polymer composite tape forming the surrounding polymer composite pipe body in order to further reduce or eliminate gas permeation.

In a further sub-aspect of this fourth aspect, a polymer composite sheet is formed by preparing an initial layer, sandwiching the initial layer between two thin film intermediate layers, sandwiching the resulting structure between two woven sheet layers, and by sandwiching that resulting structure within two thin film skin layers, and consolidating the resulting structure to form the polymer composite sheet. Such a polymer composite sheet may have an initial layer which is a stratum of metal foil, such as aluminium foil, or it may have an initial layer which is a woven sheet. Thin film layers may comprise polypropylene (or other polymer) thin film sheets, and woven sheets may comprise polypropylene (or other polymer) homopolymer fibres which have been woven into sheets such that the fibres are aligned. Consolidation may be achieved with a heated belt press or otherwise to melt the thin film sheets to provide a polymer matrix to embed the woven sheets and (if present) the stratum of metal foil. Such a polymer composite sheet may be used to form either a polymer composite internal layer and/or one or more plies of the polymer composite tape.

According to the method of the first or second alternatives of the fourth aspect of the invention, the internal layer is formed of a single longitudinal sheet of polymer composite which is bent into an annular cylinder or a broken annular cylinder around a mandrel.

In one example of the method of the first or second alternatives of the third aspect of the invention, wrapping the longitudinal sheet of polymer composite in b. is achieved by:
i. conveying the longitudinal sheet of polymer composite in a direction of travel over rollers which bend the longitudinal sheet of polymer composite into a U-shaped preform;
ii. passing the U-shaped preform through a cone-shaped funnel which is configured to wrap the U-shaped preform around a mandrel to provide the internal layer in the form of an annular cylinder or in the form of a broken annular cylinder.

The longitudinal sheet of polymer composite may additionally be heated sufficiently to render it compliant and reduce the degree of force needed to bend it into a U-shaped preform and wrap it around the mandrel.

Disposing the polymer composite pipe body around the internal layer in c. is achieved by winding one or more plies of polymer composite tape around the internal layer formed in b. According to a first alternative, the one or more plies of polymer composite tape are wound around the internal layer formed in b while it is still wrapped around the mandrel. According to a second alternative, the one or more plies of polymer composite tape are wound around the internal layer formed in b after the internal layer has been conveyed beyond the mandrel in the direction of travel. The second alternative may be used if the internal layer is stiff enough and/or the tension in the tape is sufficiently low for the internal layer not to collapse when tape is wound onto the internal layer when it is not disposed on and supported by the mandrel.

In one example, the polymer composite tape is bonded to the exterior surface of the internal layer by fusion. In one example, heat may be provided in the form of a laser beam to fuse the tape of the composite material to exterior surface of the internal layer. A laser beam may be capable of providing very localized melting and fusion at one or both of the surfaces to-be-combined, thereby ensuring that the remainder of the composite is not significantly heated and that, for example, the fibres do not soften or melt.

In one example, after the winding of a first ply of polymer composite tape, any second and further plies of polymer composite tape are bonded to the preceding layer of wound polymer composite tape by fusion. More preferably, heat is provided in the form of a laser beam to fuse the tape of the composite material to the preceding layer of wound polymer composite tape. Laser fusion/welding may have the advantages discussed above.

Typically the first two plies or even the first three or four plies of polymer composite tape are “hoop” wound. This means that they are wound at an angle close to 90°, where the longitudinal axis is defined to be 0°. An angle of precisely 90° may not be achievable in practice, so hoop windings are typically at an angle from ≥+/−81° to <90°.

The skilled person knows that the polymer composite body may comprise one or more additional plies of wound polymer composite tape and the skilled person would determine appropriate winding angles for that or those additional plies.

The methods of the first or second alternatives of the fourth aspect of the invention may be effected as continuous methods and may be employed to manufacture the polymer composite pipe in continuous long lengths, such as greater than 1000 m, greater than 2000 m or greater than 3000 m.

### BRIEF DESCRIPTION OF THE DRAWINGS

The invention will now be further described, by way of example only, and with reference to the accompanying drawing, in which:

FIG. 1 shows a schematic cross-sectional view of a cryogenic pipe arrangement.

FIG. 2 shows a schematic cross-sectional view of a stratum of metal foil bonded between two sheets of polymer composite.

FIG. 3 shows a schematic cross-sectional view of a pipe according to embodiments of the invention.

FIG. 4 shows a schematic perspective view of an apparatus used in the method according to an example of the invention.

FIG. 5 shows a method of making a polymer composite sheet for use in embodiments of the invention.

FIG. 6 shows a method of making a pipe according to an embodiment of the invention.

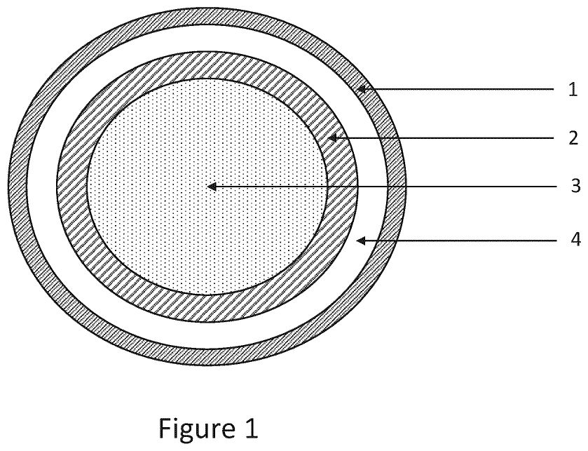

### DETAILED DESCRIPTION OF THE PREFERRED EMBODIMENTS

A detailed description of the invention will now be provided with reference to the above figures. A given reference number is always used to denote the same feature in each of the accompanying drawings.

In one example, a polypropylene single polymer composite (SPC) sheet is prepared, comprising:
extruded and drawn polypropylene homopolymer fibres which have been plane woven into sheets (woven sheets) such that the fibres are aligned either along an axis or at 90° to the axis;
a polypropylene copolymer matrix in the form of thin film sheets (thin film sheet) having a softening point which is 20° C. lower than the melting point of the polypropylene homopolymer fibres.

One or more woven sheets is encased between thin film sheets to form the SPC. If there is more than one woven sheet, then each woven sheet may be separated from the next woven sheet by a thin film sheet interposed between the woven sheets.

A “sandwich” of 500 μm thickness comprising a stratum of metal foil is prepared as follows:
A stratum of aluminium foil having a thickness of 80 μm is backed with a suitable bonding agent (known to the skilled person) to facilitate bonding to the polymer.
The stratum of aluminium foil is disposed between and bonded to two intermediate layers of thin film sheet, as discussed above, each having a thickness of 20 μm.
The arrangement is disposed between two woven sheets, as discussed above, each having a thickness of 150 μm.
The combination is sandwiched between two “skin” layers of thin film sheet, each skin layer having a thickness of 40 μm. There are thus seven layers in total, being two “skin” layers, two woven sheet layers and two intermediate layers, and an aluminium foil stratum.
The entire “sandwich” is consolidated using a heated belt press to soften or melt the thin film sheets and form the polymer matrix within which the woven sheets and the stratum of aluminium foil are embedded. Softening or melting of the polypropylene homopolymer fibres is avoided or minimized, by careful application of heat and because of the higher softening point of the homopolymer fibres.
The stratum of aluminium foil is selected to be coextensive with the woven sheets and the thin film sheets.

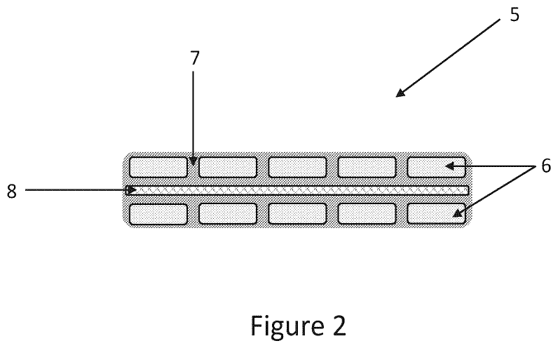

With reference to FIG. 2, a pre-consolidated “sandwich” (5) is shown comprising woven fibres (6) and a stratum of aluminium foil (8) both of which are embedded in polymer matrix (7) formed of the softened or melted thin film sheets. The woven fibres are aligned either axially (into the page) and those are the fibres which may be viewed in the figure; other fibres are aligned orthogonally thereto and, since the “cut” shown has not been made through those fibres, they are not visible in the figure. The stratum of aluminium foil (8) shown in the figure is coextensive with the polymer composite.

An internal layer comprising a stratum of aluminium foil and/or polymer composite tape comprising a stratum of aluminium foil may be cut from the “sandwich” prepared above.

An SPC arrangement of 570 μm thickness without a stratum of metal foil is prepared as follows:
Three woven sheet layers are employed, each having a thickness of 150 μm.
Each woven sheet layer is separated from the next woven sheet layer by an intermediate layer of thin film sheet, so that there are two intermediate layers of thin film sheet in total; each intermediate layer of thin film sheet has a thickness of 20 μm.
The combination is sandwiched between two “skin” layers of thin film sheet, each skin layer having a thickness of 40 μm.
There are thus seven layers in total, being two “skin” layers, three woven sheet layers and two intermediate layers.
The seven sandwiched layers are hot-compacted into an SPC of 0.57 mm thickness. During hot compaction, the thin film layers soften or melt to form the matrix. Softening or melting of the polypropylene homopolymer fibres is avoided or minimized, by careful application of heat and because of the higher softening point of the homopolymer fibres.

An internal layer and/or polymer composite tape without an embedded stratum of metal foil may be cut from the SPC arrangement prepared in this way.

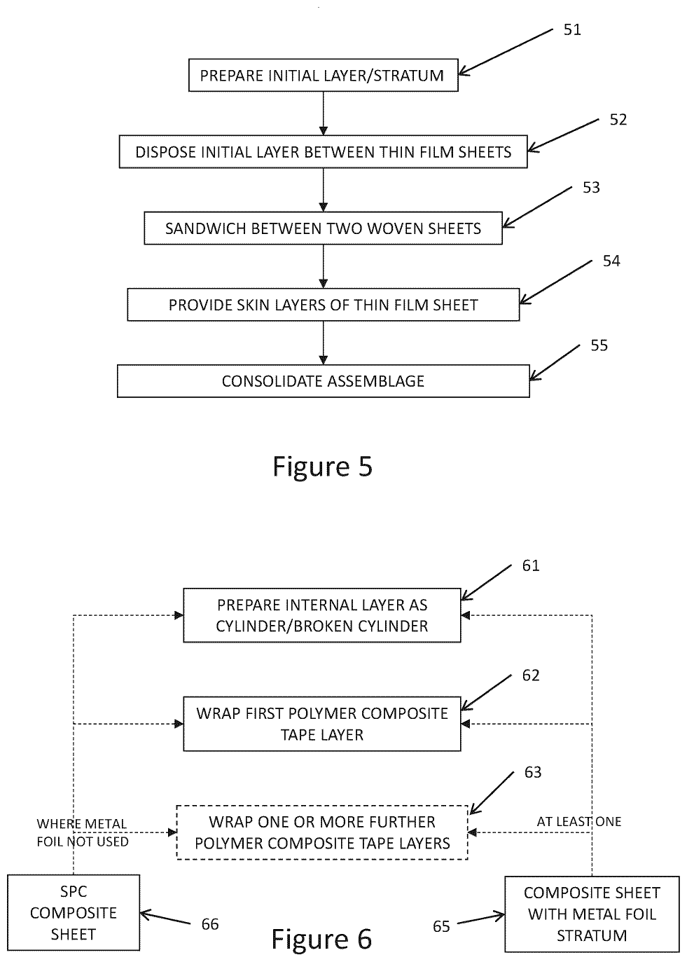

As shown in FIG. 5, these methods of sheet formation are broadly the same, differing only in the initial stage 51 of preparing an initial layer—this is provision of an aluminium foil stratum for a foil sandwich structure, and provision a woven sheet layer for an SPC sheet. The following steps, of providing 52 thin film layers to either side of the central layer, of providing 53 woven sheets around that, and providing 54 thin film sheet “skin” layers around this resulting structure and of consolidating 55 the total structure, are broadly the same in each case.

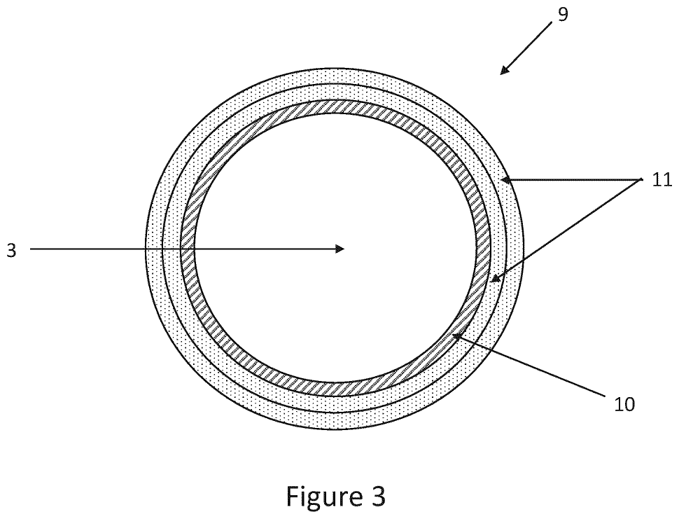

With reference to FIG. 3, a polymer composite pipe (9) having an internal diameter of 50.8 mm (2 inches) is shown, comprising:
an internal layer (10) in the form of an annular cylinder prepared from an SPC arrangement, as described above, without an embedded stratum of metal foil;
a polymer composite pipe body is bonded to the internal layer (10) and is formed of two plies (11) of polymer composite tape, the polymer composite tape having been prepared from a “sandwich” comprising an embedded stratum of aluminium foil, as described above. Both layers of polymer composite tape were wound at an angle of +85° to the longitudinal axis (the longitudinal axis being at 0°), with the tapes of the second layer being laid axially offset versus the first layer so as to overlay the contiguities between adjacent tapes of the first layer.

As shown in FIG. 6, each of these steps: provision 61 of the internal layer, provision 62 of a first composite tape layer, and optional provision of one or more further composite tape layers, is such that at least one of the layers of the resulting structure is a layer with a metal foil stratum. The remaining layers will be SPC composite sheets. It should be noted that where the metal foil stratum is provided in at least one of an unbroken cylinder internal layer or a composite tape layer, the metal foil stratum will extend over the whole cylindrical structure.

For completeness, pipes having other dimensions, such as 15.24 cm (6 inch), 20.32 cm (8 inch) or 25.4 cm (10 inch) internal diameter, etc., could also be made in this way.

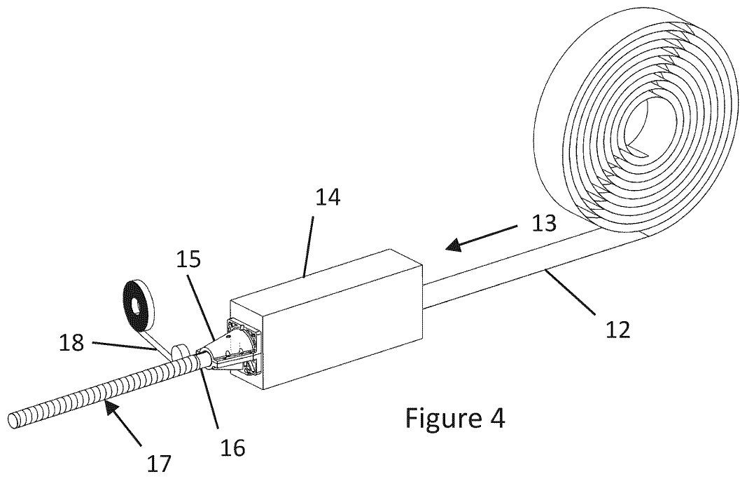

FIG. 4 shows a schematic perspective view of an apparatus used in the method according to an example of the invention and which may be used to prepare the example shown in FIG. 3.

In this method, a longitudinal sheet of SPC (12) is conveyed in a direction of travel (13) through a forming box which heats the longitudinal sheet of SPC (12) to 50-70° C. to make it more pliable. The fibres embedded in the longitudinal sheet of SPC are aligned parallel to the direction of travel (13) or are aligned at 90° to the direction of travel (13). The longitudinal sheet of SPC (12) is conveyed further in the direction of travel (13) over rollers which bend it into a U-shaped preform. The forming box and rollers are located in housing (14). The U-shaped preform is conveyed further in the direction of travel (13) through a cone-shaped funnel (15) and onto a static mandrel to wrap it into an internal layer (16) in the form of an annular cylinder. While the internal layer (16) is conveyed along the static mandrel in the direction of travel (13), layers (17) of tape (18) (having been prepared from a “sandwich” comprising an embedded stratum of aluminium foil, as described above), are wound onto the internal layer (16).

What is claimed is:

1. A polymer composite pipe having a longitudinal axis comprising:
a polymer composite internal layer in the form of an annular cylinder, or in the form of a broken annular cylinder, having an exterior surface; and
a polymer composite pipe body disposed around and bonded to the exterior surface, the polymer composite pipe body comprising at least one ply of wound polymer composite tape;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming the ply or a ply of wound polymer composite tape.

2. The polymer composite pipe of claim 1, wherein, if a stratum of metal foil is embedded in the polymer composite internal layer, then the stratum of metal foil is coextensive with the polymer composite internal layer, and if a stratum of metal foil is embedded in the polymer composite tape forming the ply or a ply of wound polymer composite tape, then the stratum of metal foil is coextensive with that polymer composite tape.

3. The polymer composite pipe of claim 1, wherein the stratum of metal foil or a stratum of metal foil is embedded in the polymer composite tape forming the first ply of wound polymer composite tape, which is the ply bonded to the internal layer.

4. The polymer composite pipe of claim 3, wherein the polymer composite pipe body comprises a second ply of wound polymer composite tape bonded to the first ply of wound polymer composite tape, and wherein a stratum of metal foil is embedded in the second ply of wound polymer composite tape.

5. The polymer composite pipe of claim 1, wherein the metal foil comprises a metal selected from aluminium, copper, steel, titanium, or a mixture of one or more of those metals, or an alloy of one of those metals.

6. The polymer composite pipe of claim 5, wherein the metal foil comprises aluminium.

7. The polymer composite pipe of claim 1, wherein the stratum of metal foil has a thickness from 1 μm to 100 μm.

8. The polymer composite pipe of claim 7, wherein the stratum of metal foil has a thickness from 20 μm to 85 μm.

9. The polymer composite pipe of claim 1, wherein:
if the stratum of metal foil is embedded in the polymer composite internal layer, then the polymer composite internal layer comprises the stratum of metal foil bonded between two sheets of polymer composite; and
if the stratum of metal foil is embedded in the polymer composite tape forming a ply of wound polymer composite tape, then that polymer composite tape comprises the stratum of metal foil bonded between two sheets of polymer composite.

10. The polymer composite pipe of claim 1, wherein the internal layer comprises first polymer fibres embedded in a first polymer matrix, and the first polymer fibres and the first polymer matrix comprise the same polyolefin.

11. The polymer composite pipe of claim 10, wherein both the first polymer fibres and the first polymer matrix consist of polypropylene or a copolymer thereof.

12. The polymer composite pipe of claim 1, wherein the polymer composite tape comprises second polymer fibres embedded in a second polymer matrix, and the second polymer fibres and the second polymer matrix comprise the same polyolefin.

13. The polymer composite pipe of claim 12, wherein both the second polymer fibres and the second polymer matrix consist of polypropylene or a copolymer thereof.

14. The polymer composite pipe of claim 1, wherein the internal layer comprises first polymer fibres embedded in a first polymer matrix, the polymer composite tape comprises second polymer fibres embedded in a second polymer matrix, and the first polymer matrix and the second polymer matrix comprise the same polyolefin.

15. The polymer composite pipe of claim 14, wherein the first polymer matrix and the second polymer matrix consist of polypropylene or a copolymer thereof.

16. The polymer composite pipe of claim 1 comprising a fluid having a temperature below −30° C.

17. A cryogenic pipe arrangement comprising the polymer composite pipe of claim 1 disposed within an outer pipe such that there is a gap between the polymer composite pipe and the outer pipe, the arrangement being adapted to create and sustain a vacuum within the gap.

18. The use of the polymer composite pipe of claim 1 for conveying a fluid having a temperature below −30° C.

19. A method of manufacturing a polymer composite pipe having a longitudinal axis and comprising a polymer composite internal layer and a polymer composite pipe body, the method comprising:
providing a longitudinal sheet of polymer composite having a sheet width defined between a first longitudinal side edge and a second longitudinal side edge;
wrapping the longitudinal sheet of polymer composite around the longitudinal axis, such that the first longitudinal side edge and the second longitudinal side edge are contiguous or overlap one another to provide the internal layer which has the form of an annular cylinder having an exterior surface; and
disposing the polymer composite pipe body around the internal layer by winding at least one ply of polymer composite tape around the exterior surface and bonding it to the exterior surface;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming a ply of wound polymer composite tape.

20. A method of manufacturing a polymer composite pipe having a longitudinal axis and comprising a polymer composite internal layer and a polymer composite pipe body, the method comprising:
providing a longitudinal sheet of polymer composite having a sheet width defined between a first longitudinal side edge and a second longitudinal side edge;
wrapping the longitudinal sheet of polymer composite around the longitudinal axis to provide the internal layer in the form of a broken annular cylinder having a circumference which is greater than the sheet width, so that the internal layer comprises a longitudinally extending break defined between the first longitudinal side edge and the second longitudinal side edge; and
disposing the polymer composite pipe body around the internal layer by winding at least one ply of polymer composite tape around the exterior surface and bonding it to the exterior surface;
wherein a polymer composite is a material comprising polymer fibres embedded in a polymer matrix; and
wherein a stratum of metal foil is embedded in the polymer composite internal layer and/or a stratum of metal foil is embedded in the polymer composite tape forming a ply of wound polymer composite tape.
